(19) United States
(12) Patent Application Publication
(10) Pub. No.: US 2010/0242064 A1
(43) Pub. Date: Sep. 23, 2010

(54) SYSTEMS AND METHODS FOR PROVIDING A DYNAMIC USER INTERFACE FOR A SETTOP BOX

(75) Inventor: Charles Dasher, Lawrenceville, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Tandberg Television, Inc.

(21) Appl. No.: 12/406,493

(22) Filed: Mar. 18, 2009

(51) Int. Cl. G06F 13/00; H04N 7/173; H04N 5/445

(52) U.S. Cl. 725/34; 725/110; 725/61

(57) ABSTRACT

Various embodiments of the present invention provide systems and methods for providing a dynamic user interface for a settop box, and more specifically, to systems and methods for providing a dynamic user interface for a settop box by utilizing one or more I-frames based on user inputs. In particular embodiments, the systems and methods receive one or more inputs from a user and generate I-frames based on the user's inputs. In various embodiments, the I-frames are sent to the user's settop box and are decoded to generate a signal for displaying images to the user.

### BACKGROUND OF THE INVENTION

1. Field of the Invention

The disclosed invention generally relates to systems and methods for providing a dynamic user interface for a settop box, and more specifically, to systems and methods for providing a dynamic user interface for a settop box by utilizing I-frames based on user input.

2. Description of the Related Art

Today, many cable and satellite TV providers offer a wide range of products and services to their customers. One such service is video on demand (VOD) programming or audio video on demand (AVOD) that allow subscribers to select and watch/listen to video and/or audio content on demand. A subscriber is provided with a listing of VOD content and the subscriber selects a particular content (such as a movie, television program, or music program), and the VOD service (system) either streams the content through the subscriber's settop box or downloads the content to the subscriber's settop box for viewing/listening.

A common problem experienced by many subscribers using a VOD service is that the menus provided with the service for displaying the available content are lacking in their ability to allow subscribers to search for and watch content. For example, many of the menus associated with VOD service simply provide pages of listings of content and only allow users to scroll through these pages to locate a desired asset (e.g., content). Therefore, many times a subscriber is required to scroll through pages and pages of listings of content to find a desired asset to view or listen to. As a result, subscribers may become frustrated over the amount of time spent to locate a particular asset and/or the inability to locate the particular asset at all. This problem becomes even more pronounced as the amount of available content grows for a cable and satellite TV provider (e.g., the number of assets available for viewing becomes larger). Thus, a need exists for a user interface that allows subscribers to better search for content within an environment such as a VOD service on a settop box.

Furthermore, millions of subscribers have legacy settop boxes in their homes. Many of these legacy settop boxes are older and less-equipped models than the newer state-of-the-art models available today, and as a result these boxes cannot support complex applications. In addition, many of the subscribers with these boxes are reluctant (or are unable) to upgrade their legacy settop boxes. For instance, many subscribers (and/or providers for that matter) may not want to incur the cost of buying or leasing new settop boxes. Thus, cable and satellite TV providers also desire a solution that provides a more interactive user interface for their VOD services that would not require the providers to replace these millions of legacy settop boxes.

### BRIEF DESCRIPTION OF THE DRAWINGS

Having thus described various embodiments of the invention in general terms, reference will now be made to the accompanying drawings, which are not necessarily drawn to scale, and wherein:

FIG. 1 is a flow diagram illustrating the process for providing a dynamic user interface for searching VOD content on a settop box according to various embodiments of the invention.

FIG. 2 is a schematic diagram illustrating a media content providing system according to various embodiments of the invention.

FIG. 3 is a schematic diagram illustrating a settop box residing in the media content providing system shown in FIG. 1 according to various embodiments of the invention.

FIG. 4 is a schematic diagram illustrating an I-frame server residing in the media content providing system shown in FIG. 1 according to various embodiments of the invention.

FIG. 5 is a flow diagram of an interactive client module according to various embodiments of the invention.

FIG. 6 is a flow diagram of a VOD client module according to various embodiments of the invention.

FIG. 7 is a flow diagram of a routing module according to various embodiments of the invention.

FIG. 8 is a flow diagram of an I-frame module according to various embodiments of the invention.

FIG. 9 is a flow diagram of a search content module according to various embodiments of the invention.

FIG. 10 is a flow diagram of a web content module according to various embodiments of the invention.

### DETAILED DESCRIPTION OF THE INVENTION

The present invention now will be described more fully with reference to the accompanying drawings, in which some, but not all embodiments of the invention are shown. Indeed, this invention may be embodied in many different forms and should not be construed as limited to the embodiments set forth herein. Like numbers refer to like elements throughout.

As will be appreciated by one skilled in the art, the present invention may be embodied as a method, a data processing system, or a computer program product. Accordingly, the present invention may take the form of an entirely hardware embodiment, an entirely software embodiment, or an embodiment combining software and hardware aspects. Furthermore, the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, flash drives, or magnetic storage devices.

The present invention is described below with reference to block diagrams and flowchart illustrations of methods, apparatuses (e.g., systems and devices) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, a special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations for performing the specified functions, combinations of steps for performing the specified functions and program instructions for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

### Brief Overview of an Embodiment

Various embodiments of the present invention provide systems and methods for providing a dynamic user interface by utilizing I-frames. For example, various embodiments of the present invention provide systems and methods for providing a dynamic user interface by utilizing I-frames for searching available video on demand (VOD) content offered by a cable service provider or a satellite TV provider. The term “provider” is used from this point forward to indicate a cable service provider or a satellite TV provider or any other provider of media content.

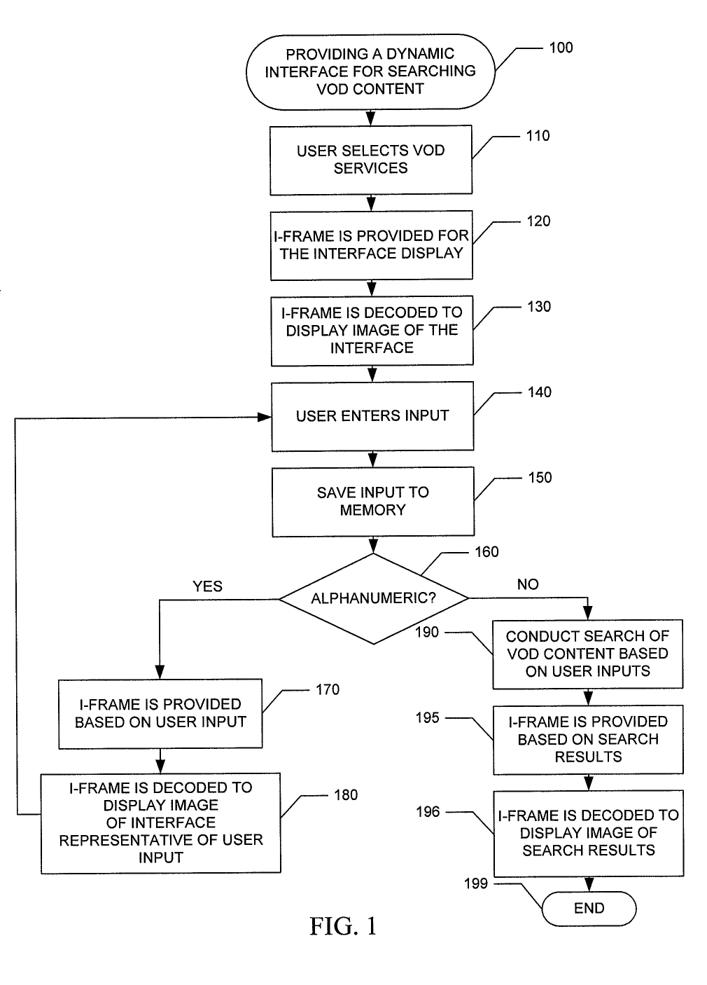

FIG. 1 illustrates a flow diagram of a process 100 for providing a dynamic user interface for searching VOD content offered by a provider according to an embodiment of the invention. The process begins at Step 110 with the user selecting to view the provider's VOD service on the user's television. For instance, the user selects a button on the user's remote control signaling the settop box to bring up a menu for such service. In this particular embodiment, the user's request to bring up the VOD service is sent over a network to a server located at the head end of the provider's system.

For instance, in one embodiment, a VOD server receives the request and sends a command to an I-frame module to provide an I-frame that can be used to provide a search interface for the user. In various embodiments, the I-frame module may reside on the VOD server or on another server.

At Step 120, the I-frame module receives the command and provides the I-frame. In one embodiment, the I-frame module generates the I-frame to provide an image of a VOD service interface. In another embodiment, the I-frame module retrieves the I-frame from memory. While in another embodiment, the I-frame module does both. For instance, the module retrieves a “template” I-frame that represents a basic user interface and modifies the I-frame to customize the interface. For example, the module inserts advertisements into the interface or adds personal settings to the interface based on the user's preference.

In various embodiments, once the I-frame is generated, the I-frame module sends the I-frame to the VOD server and the server forwards the I-frame to the settop box. The settop box decodes the I-frame into a signal for displaying an image of the interface on the user's television screen, shown as Step 130. Since the I-frame is encoded as a single image, the image is repeatedly run on the user's settop box to provide the look of an interface on the user's television screen.

In various embodiments, the interface may include a mechanism by which the user can conduct a search of the available VOD content. For example, in one embodiment, the interface includes one or more text boxes in which the user can enter alphanumeric characters for use as criteria to conduct a search to identify available VOD content that satisfy the criteria.

In Step 140, the user types in the first alphanumeric character of the criteria into the text box provided on the interface (such as the letter “N” for “New Releases”) by using an input device such as a remote control or a keyboard in communication with the settop box. The settop box receives the input and sends the input to the VOD server located at the head end of the provider's system.

In this particular embodiment, in Step 150, the VOD server stores the input in memory (such as a buffer). The VOD server then evaluates whether the input is an alphanumeric character, shown as Step 160. If the input is an alphanumeric character, the VOD server forwards a command to the I-frame module to provide an I-frame based on the user's input.

In response, the I-frame module receives the command and provides an I-frame based on the user's input, shown as Step 170. In this case, the I-frame module provides an I-frame with an image of the interface with the letter “N” typed into the text box on the interface. The I-frame module sends the I-frame to the VOD server and the VOD server forwards the I-frame to the user's settop box.

In Step 180, the settop box decodes the I-frame into a signal for displaying the image on the user's television screen. As a result, it appears to the user as though he or she has just typed the letter “N” into the text box shown on the interface,

The user enters the next alphanumeric character (e.g., “e”) and the settop box sends the input to the VOD server, shown as Step 140. In Step 150, the VOD server stores the input along with the user's first input in memory. The VOD server then evaluates whether the input is an alphanumeric character, shown as Step 160. If the VOD server determines the character is alphanumeric, the VOD server sends a command to the I-frame module to provide an I-frame based on the input and any previous alphanumeric input received from the user (e.g., an I-frame based on the inputs “N” and “e”). Thus, the I-frame module provides an I-frame based on the two inputs and sends the I-frame back to the VOD server, shown as Step 170. The VOD server forwards the I-frame to the user's settop box and the settop box decodes the I-frame into a signal displaying an image on the user's television screen, shown as Step 180. As a result, it appears to the user as though he or she has now typed the letters “N” and “e” into the text box shown on the interface. Thus, this process is repeated for each remaining letter the user types in as input for the desired search criteria.

In various embodiments, the interface also provides a mechanism, such as a “Search” button, that is selected by the user once the user has entered the entire desired criteria for the search (e.g., the user has entered “New Releases”). The user enters input by selecting the search button (shown as Step 140) and in response the settop box sends the input (e.g., a non-alphanumeric indicator that the “Search” button has been selected) to the VOD server and the VOD server stores the input in memory (shown as Step 150). In Step 160, the VOD server evaluates the input to determine whether the input is alphanumeric. In this case, the input is not alphanumeric. Therefore, in response the VOD server retrieves the previous inputs by the user from memory (e.g., retrieves the alphanumeric inputs “New Releases”) and conducts a search of the provider's available VOD content to determine a listing of the VOD content that satisfies the search criteria, shown as Step 190. The VOD server sends a command to provide an I-frame along with the results to the I-frame module.

In Step 195, the I-frame module provides an I-frame based on the search results and sends the I-frame to the VOD server. The VOD server forwards the I-frame to the user's settop box. The user's settop box receives the I-frame and decodes it into a signal displaying an image of the search results on the user's television screen, shown as Step 196. The user can browse the results and select a particular content to view (such as a movie) thus ending the process, shown as Step 199. In various embodiments, the settop box receives the user's selection and requests the particular content via the provider's VOD service.

This particular embodiment of the process 100 provides a dynamic interface that can be used to search for available VOD content offered by a user's provider without having to scroll through the numerous pages listing content that is typically associated with a VOD service. In addition, this embodiment of the process 100 provides a dynamic interface that can be used on any number of legacy settop boxes. This is because the process 100 in various embodiments uses program modules and equipment typically found in many legacy settop boxes.

It should be noted that this process 100 may also be used to provide interfaces with regard to other services rendered on a settop box. For example, this process 100 may be used to provide an Internet browser. Thus, the generated I-frame may provide an image of a web site found on the Internet. A server located at the head end of the provider's system may be in communication with the Internet. Thus, this web server may query information from the Internet and an I-frame may be generated based on the queried information (e.g., an I-frame may be generated that resembles a web site). As a result, the user may browse the Internet simply through the user's settop box.

Furthermore, this process 100 may be used to provide service information to the user. For example, the provider may be able to provide the user (e.g., subscriber) with his or her billing information via this process 100 and the user may be able to pay his or her monthly bill directly through the user's settop box. In addition, the service industry, such as a hotel, may be able to provide interactive information to a guest over the television set in the guest's room. Furthermore, merchants may be able to provide interactive advertisement to a user's settop box and/or conduct sales transactions through a user's settop box by using this process 100.

### System Architecture

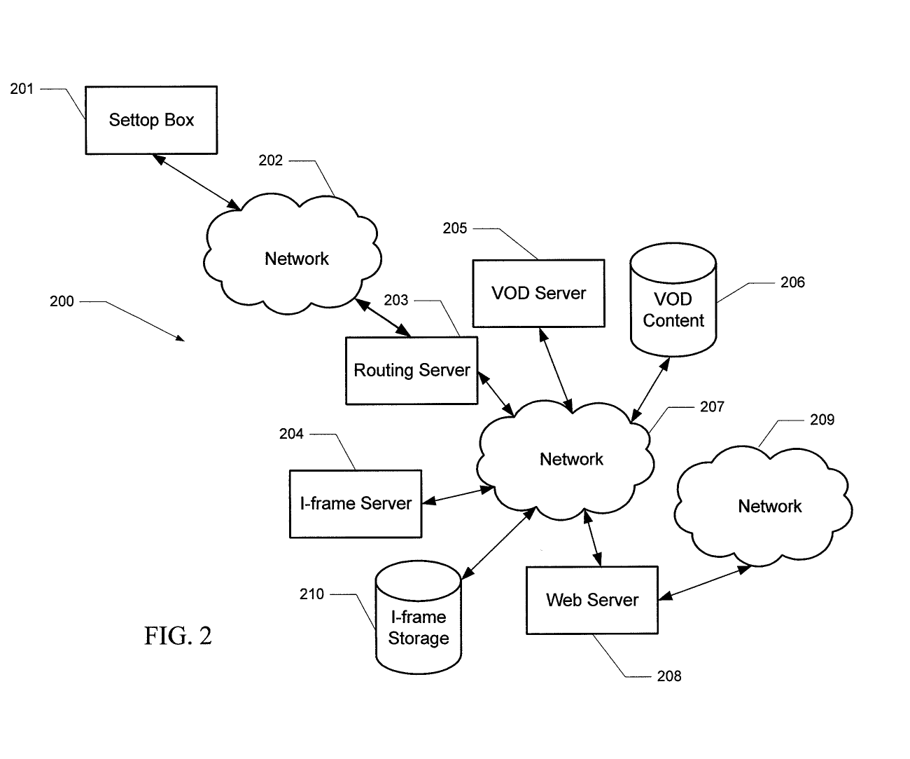

A media content providing system 200 according to various embodiments of the invention is shown in FIG. 2. For instance, the system 200 may be a cable provider's system 200 providing cable programming to the cable provider's subscribers. However, the system 200 may also be a satellite TV provider's system or an Internet provider's system. Therefore, the system 200 depicted in FIG. 2 is provided for illustrative purposes only and in no way should be construed to limited the scope of the claimed invention.

As may be understood from this figure, in various embodiments, the system 200 includes a settop box 201. The settop box 201 is a device that is used by an individual to receive a digital cable signal for a television. For example, the settop box 201 may be a device, such as a personal video recorder (PVR) provided by a cable company. The PVR receives the digital cable signal and feeds the signal into an individual's television set so that the individual can view the cable company's cable television programming.

However, the settop box 201 does not necessary need to be a digital cable box for a television. For instance, in other embodiments, the settop box 201 may be a computing device, such as an individual's desktop computer or laptop computer, configured to receive media signals over a network.

In various embodiments, the settop box 201 communicates with a routing server 203 over a network 202. The routing server 203 routes messages (e.g., user input) to various components of the provider's system 200 and routes messages (e.g., VOD content) to the settop box 201. For instance, in one embodiment, the routing server 203 receives input from the user via the settop box 201, interprets the input, and sends the input to the appropriate component of the system 200, such as the VOD server 205. Other embodiments of the system 200 do not include the routing server 203 and the settop box 201 routes input directly to the components of the system 200.

In addition, the system 200 of various embodiments may also include an I-frame server 204, a video on demand (VOD) server 205, and a web server 208. In various embodiments, these servers are configured to perform specific functions within the system 200. For instance, as will be described in further detail below, the I-frame server 204 is configured to provide I-frames based on user input received by the settop box 201 or other components of the system 200.

In various embodiments, the VOD server 205 is configured to provide video on demand features to the users of the system 200 and to search the provider's VOD content based on search criteria entered by the user. The web server 208, in various embodiments, is configured to serve as an interface between the system 200 and various external systems. For instance, the web server 208 may access web sites, submit user input, and receive content from the web sites based on the user input. In various embodiments, the web server 208 communicates with the external systems over a network 209, such as the Internet. Furthermore, several of these components of the system 200 are connected via a network 207 within the media content providing system 200 (e.g., a LAN, the Internet, a wireless network, and/or a private network) and communicate with one another.

In addition, as depicted in FIG. 2, the system 200 may also include storage medium, such as VOD content storage 206 and I-frame storage 210. The storage medium 206, 210 is also connected via the network 207 and communicates with other components of the system 200. In various embodiments, the VOD content storage 206 stores the provider's VOD content and associated information, such as program guides detailing the available VOD content. In various embodiments, the I-frame storage 210 stores I-frames that may be pooled for use.

In various embodiments, the components 201, 203, 204, 205, 206, 208, 210 may be one or more devices or software programs running on one or more devices. Furthermore, in various embodiments, the storage medium 206, 210 may be one or more types of medium such as hard disks, magnetic tapes, or flash memory.

### Exemplary Settop Box

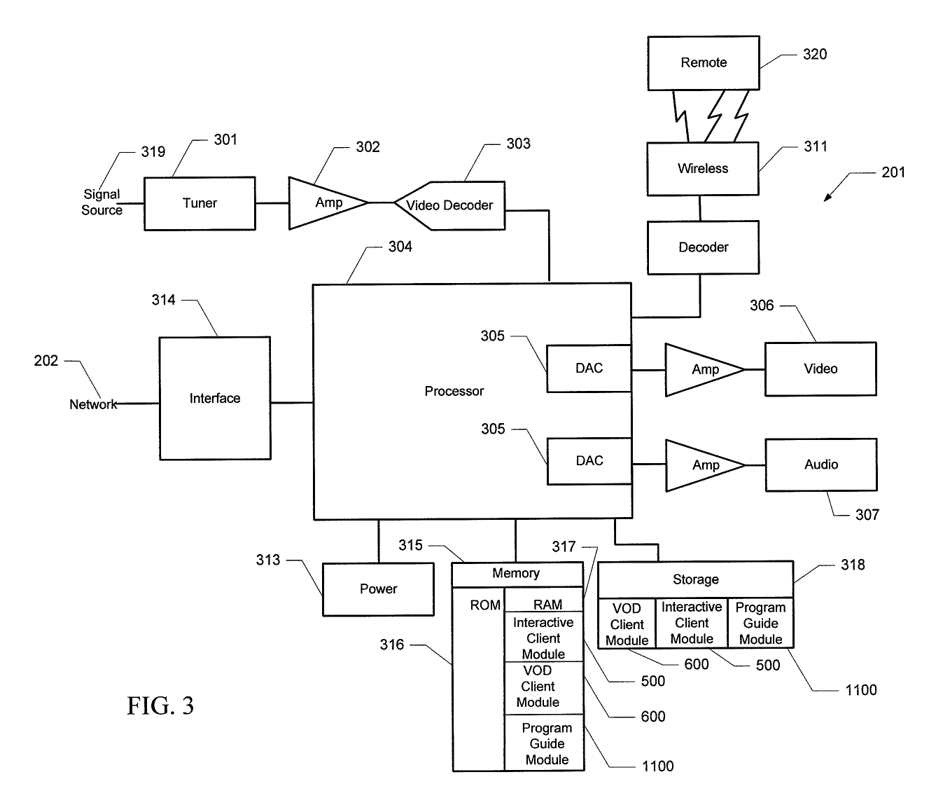

FIG. 3 shows a schematic diagram of a settop box 201 according to one embodiment of the invention. The particular settop box 201 depicted in FIG. 3 is configured to receive a digital signal from a cable provider or a satellite TV provider and to convert the signal into audiovisual content that is typically displayed on a television. However, as noted above, the settop box 201 is not limited to a device used to receive a digital signal from a cable company. For example, the settop box 201 may be a device configured to receive a digital music signal from a satellite radio provider or an individual's computing device. Thus, the settop box 201 depicted in FIG. 3 is for illustrative purposes only, and in on way should be construed to limit the scope of the invention.

The particular embodiment of the settop box 201 shown in FIG. 3 includes a processor 304 and storage 318, such as a hard disk drive and/or a flash drive, on which audiovisual data may be recorded and stored by the processor 304. In addition, the settop box 201 further includes memory 315 composed of both read only memory (ROM) 316 and random access memory (RAM) 317.

The settop box 201 further includes a tuner 301 configured to receive the incoming source signal 319. The tuner 301 sends the source signal 319 through an amplifier 302 and a video decoder 303 configured to translate the encoded source signal 319 into its original format. The video decoder 303 directs the translated source signal 319 to the processor 304.

In various embodiments, the processor 304 may also include a digital-to-analog converter (DAC) 305, 306 configured to convert the translated source signal 319 from a digital signal to an analog signal if the television will only read an analog signal. Furthermore, the processor 304 is configured to feed the translated signal to the video and audio outputs 306, 307 of the settop box 201 that are connected to the television.

In addition, the settop box 201 may also include a wireless interface 311 that is configured to receive commands (and/or input) from the individual via transmission from a remote control 320. The remote control 320 may transmit such commands using any number of transmitters, such as a radio frequency transmitter, a supersonic transmitter, or an optical transmitter.

A number of program modules may also be stored within the storage 318 and/or within the RAM 217 of the settop box 201. For example, an interactive client module 500, a VOD client module 600, and a program guide module 1100 may be stored within the storage 318 and/or RAM 317. These modules 500, 600, 1100 may be used to control certain aspects of the operation of the settop box 201, as is described in more detail below, with the assistance of the processor 304.

Also located within the settop box 201 is an interface 314, for interfacing and communicating with other elements of a network (such as the network 202 discussed in the media content providing system 200 described above.) It will be appreciated by one of ordinary skill in the art that one or more of the settop box's 201 components may be located geographically remotely from other settop box 201 components. Furthermore, one or more of the components may be combined, and additional components performing functions described herein may also be included in the settop box 201.

### Exemplary Server

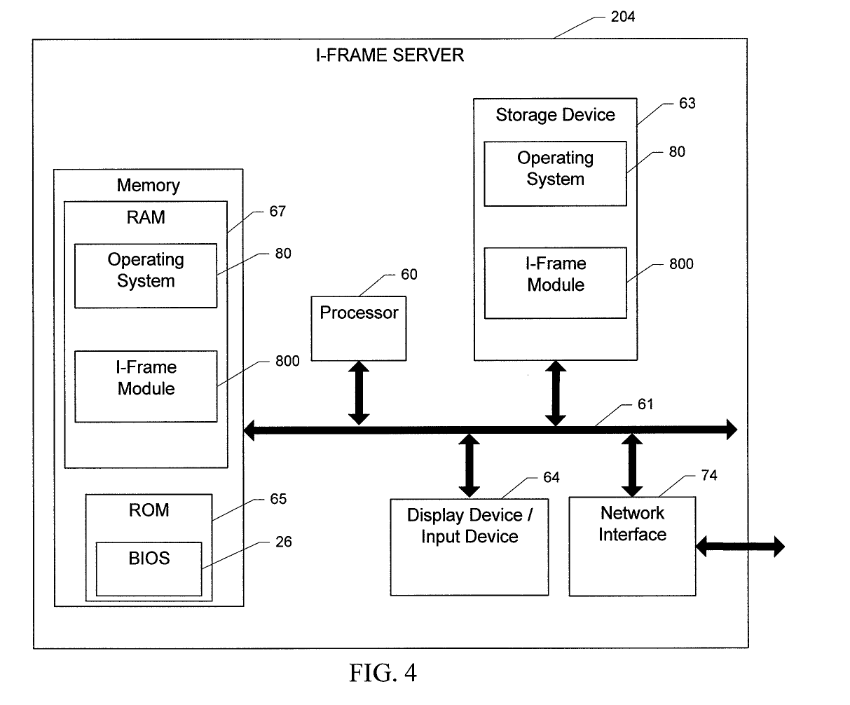

FIG. 4 shows a schematic diagram of one of the servers in the media content providing system 200 depicted in FIG. 2 according to one embodiment of the invention. For example, the server may be the routing server 203, the I-frame server 204, the VOD server 205, or the web server 208 shown in FIG. 2. However, for purposes of illustration, an embodiment of the I-frame server 204 is specifically shown in FIG. 4. Though, in various embodiments, the other servers 203, 205, 208 have a similar structure.

In FIG. 4, the server 204 includes a processor 60 that communicates with other elements within the server 204 via a system interface or bus 61. Also included in the server 204 is a display device/input device 64 for receiving and displaying data. This display device/input device 64 may be, for example, a keyboard or pointing device that is used in combination with a monitor. The server 204 further includes memory 66, which preferably includes both read only memory (ROM) 65 and random access memory (RAM) 67. The server's ROM 65 is used to store a basic input/output system 26 (BIOS), containing the basic routines that help to transfer information between elements within the server 204. Alternatively, the server 204 can operate on one computer or on multiple computers that are networked together.

In addition, the server 204 includes at least one storage device 63, such as a hard disk drive, a floppy disk drive, a CD Rom drive, flash drive, or optical disk drive, for storing information on various computer-readable media, such as a hard disk, a removable magnetic disk, or a CD-ROM disk. As will be appreciated by one of ordinary skill in the art, each of these storage devices 63 is connected to the server bus 61 by an appropriate interface. The storage devices 63 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 67. For example, as shown in FIG. 4, program modules of the I-frame server 204 may include an operating system 80 and an I-frame module 800. The I-frame module 800 may be used to control certain aspects of the operation of the I-frame server 204, as is described in more detail below, with the assistance of the processor 60 and an operating system 80.

Also located within the server 204 is a network interface 74, for interfacing and communicating with other elements of one or more networks (such as the network 207 described in the media content providing system 200 depicted in FIG. 2.) It will be appreciated by one of ordinary skill in the art that one or more of the server's 204 components may be located geographically remotely from other server 204 components. Furthermore, one or more of the components may be combined, and additional components performing functions described herein may be included in the system 200.

### Exemplary System Operation

As mentioned above, the system 200 according to various embodiments provides a dynamic interface for a settop box 201. In particular embodiments, the settop box 201 includes an interactive client module 500, a VOD client module 600, and a program guide module 1100. The interactive client module 500 is configured to receive, decode, present, and process enhanced television (ETV) applications. In various embodiments, this particular module 500 provides a user with one or more mechanisms to navigate and interact with multimedia content represented by ETV applications. The VOD client module 600 is configured to provide VOD service to the user and to request that particular media content be streamed (or downloaded) to the user's settop box 201 for viewing. The program guide module 1100 is configured to provide programming information (e.g., listings of available programming from the provider). In various embodiments, the routing server 203 includes a routing module 700 configured to route messages (e.g., user input) to various components of the system 200. In various embodiments, the I-frame server 204 includes an I-frame module 800. This module 800 is configured to provide I-frames based on commands received from various components of the system 200 for routing to the user's settop box 201 for viewing. In various embodiments, the VOD server 205 includes a VOD module 900 that is configured to search the available VOD content offered by the provider. Furthermore, in various embodiments, the web server 208 includes a web content module 1000. This module 1000 is configured to access various Internet content (e.g., web sites) and to receive information from the Internet. These modules 500, 600, 700, 800, 900, 1000, 1100 are described in more detail below.

### Interactive Client Module

The interactive client module 500 is a component of a typical enhanced television (ETV) system, which provides a way to deploy interactive TV applications to many legacy settop boxes. Such a system involves binding an interactive application to video programming that is streamed to a user's settop box 201 and executing the application concurrently with the program.

As previously mentioned, the interactive client module 500 resides on a user's settop box 201 and is configured to interpret (e.g., receive, decode, present, and process) interactive applications. In many cases, these types of applications provide such content as overlaid banners presented on top of programming content or spot advertisements. Furthermore, the applications may request input from the user by prompting users to take specific actions (such as depressing one or more buttons on a remote control). Thus, the interactive client module 500 is further configured to receive input from the user.

In various embodiments of the present invention, the interactive client module 500 is utilized to receive user input associated with a user interface provided via one or more I-frames. In various embodiments, the interactive client module 500 is simply adapted to pass the user input through to various components of the provider's system 200, such as the routing server 203 depicted in FIG. 2. While in other embodiments, the interactive client module 500 is configured to evaluate the user input and direct the input to various components of the provider's system based on the input.

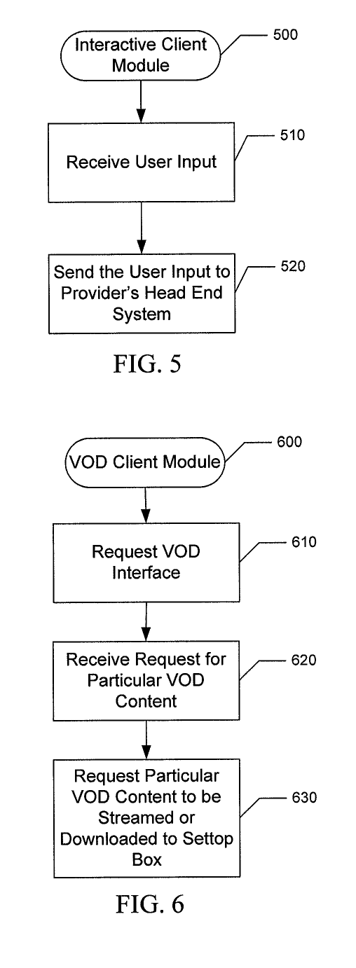

Accordingly, FIG. 5 illustrates a flow diagram of the interactive client module 500 used according to various embodiments of the invention. This flow diagram may correspond to the steps carried out by the processor 304 in the settop box 201 shown in FIG. 3 as it executes the module 500 in the box's 201 RAM memory 317 according to various embodiments.

In various embodiments, the interactive client module 500 receives input from the user. For instance, the user may decide to access the VOD service provided by the user's provider and selects a button on his or her remote control in communication with the user's settop box 201 that signals the settop box 201 to access the VOD service menu. In various embodiments of the invention, the interactive client module 500 receives input indicating the user's request, shown as Step 510. In response, the interactive client module 500 sends the user input to the provider's system 200, shown as Step 520.

For instance, in one embodiment, the interactive client module 500 sends the input to the routing server 203 as shown in FIG. 2. In this particular embodiment, the routing server 203 interprets the input and directs the input to the corresponding component. Therefore, in the above example, the routing server 203 (and corresponding routing module 700) interprets the input and directs the input to the VOD server 205. As is described in more detail below, the VOD server 205 of various embodiments may request an I-frame from the I-frame module 800, may search the available VOD content, or may stream (or download) VOD content to the user's settop box 201 in response to the user's input.

However, in another embodiment, the interactive client module 500 sends the input directly to the intended component of the provider's system 200. For example, the provider's system 200 may not include the routing server 203 in particular embodiments and the interactive client module 500 interprets the user's input and sends the user's input directly to the appropriate component of the system 200, such as the VOD server 205, the I-frame server 204, or the web server 208. Therefore, in the above example, the interactive client module 500 sends the user's request to access the provider's VOD service directly to the VOD server 205.

As previously discussed, in various embodiments, the VOD server 205 receives the request and sends a command to the I-frame server 204. The I-frame server 204 provides an I-frame based on the command and returns the I-frame to the VOD server 205. The VOD server 205 then forwards the I-frame to the user's settop box 201 and the settop box 201 decodes the I-frame into a signal displaying an image on the user's television screen. The image may display various types of information. For instance, the image may display an interface that can be used to search the provider's available VOD content.

Furthermore, it should be appreciated that in various embodiments the user may be provided with VOD service that uses a combination of the menus displayed for a typical VOD service and I-frames provided via the I-frame server 204. Thus, in one embodiment, the user may be initially presented with a menu typically found in many VOD services and I-frame images may be provided as a result of further navigation of the service by the user and/or input entered by the user.

### VOD Client Module

As previously discussed, in various embodiments, the user's settop box 201 may also include a VOD client module 600 that is configured to implement VOD service on the user's settop box 201. Furthermore, in various embodiments, the VOD client module 600 is configured to work in conjunction with the interactive client module 500 to provide the dynamic interface for the VOD service to the user. Accordingly, FIG. 6 illustrates a flow diagram of a VOD client module 600 working in conjunction with the interactive client module 500 according to various embodiments. This flow diagram may correspond to the steps carried out by the processor 304 in the settop box 201 shown in FIG. 3 as it executes the module 600 in the box's 201 RAM memory 317 according to various embodiments.

In various embodiments, the user may request to bring up the VOD service on the user's television screen and the VOD server 205 may request the I-frame server 204 for an initial I-frame to serve as an initial menu screen. Therefore, in these embodiments, the VOD client module 600 may send the request for the interface to the VOD server 205, shown as Step 610. In one embodiment, the VOD client module 600 sends the request through the interactive client module 500 to the VOD server 205. The VOD server 205 receives the request, and if appropriate, sends a command to the I-frame server 204. In another embodiment, the VOD client module 600 sends the requests directly to the VOD server 205. Furthermore, in various embodiments, the request may also be routed through the routing server 203.

In other embodiments, the VOD client module 600 uses screens (e.g., menus) that are provided with the VOD client module 600 as well as uses screens (e.g., menus) provided through I-frames to display the VOD service to the user. For instance, when the user request to bring up the VOD service on the user's television screen, the VOD client module 600 brings up an initial screen that is provided with the VOD client module 600 (e.g., brings up the initial menu provided with many traditional VOD services). For example, in one embodiment, the VOD client module 600 requests programming information from the program guide module 1100 and the program guide module 1100 sends information on available VOD content to VOD client module 600 to display to the user. In another embodiment, the program guide module 1100 receives the request from the VOD client module 600 and the program guide module 1100 provides the initial menu directly to the user. In these particular embodiments, the VOD client module 600 may then use I-frames to provide menus when a user requests to perform a search for particular VOD content (e.g., assets). Therefore, the VOD client module 600 requests an I-frame to provide such an interface. As a result, the VOD client module 600 uses a combination of screens provided with the VOD client module 600 and screens provided through I-frames to present the VOD service to the user.

Furthermore, in various embodiments, the VOD client module 600 is responsible for requesting a particular selection of VOD content (e.g., movie or television program) made by the user. Thus, in various embodiments, the user may select a particular VOD asset listed on the provided interface to view on his or her television. For instance, the user may be viewing a listing of VOD content returned from a search performed based on criteria entered by the user. The screen displaying the listing may have been provided via an I-frame generated by the I-frame server 204. The user selects a particular asset (such as a movie) and, in Step 620, the VOD client module 600 receives the request for the particular VOD asset (e.g., receives the user's selection of a movie), and requests the particular VOD asset to be streamed (or downloaded) to the user's settop box 201, shown as Step 630.

In various embodiments, the VOD client module 600 requests the desired content from a server located at the head end of the provider's system. For example, the VOD client module 600 requests the desired content from the VOD server 205 shown in the system 200 depicted in FIG. 2. Thus, the VOD client module 600 sends the request over the provider's network 202 and the VOD server 205 receives the request. In various embodiments, the VOD server 205 may retrieve the particular content from a storage medium. For example, the VOD server 205 may retrieve the particular content from the VOD content storage 206. Therefore, the VOD server 205 receives the request from the VOD client module 600, retrieves the requested asset from the VOD content storage 206, and streams (or downloads) the requested asset to the user's settop box 201. The user's settop box 201 then displays the content (e.g., plays the movie) on the user's television via the VOD service.

### Routing Module

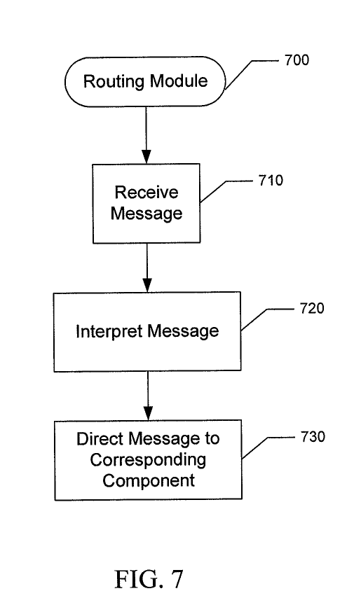

As previously discussed, in various embodiments, the provider's system 200 may include a routing server 203. Furthermore, in various embodiments, the routing server 203 may include a routing module 700 that is configured to route messages between settop boxes 201 of the provider's system 200 and the various other components located at the head end of the provider's system 200. Accordingly, FIG. 7 illustrates a flow diagram of a routing module 700 according to various embodiments. This flow diagram may correspond to the steps carried out by the processor in the routing server 203 as it executes the module 700 in the server's 203 RAM memory according to various embodiments.

Thus, in Step 710, the routing module 700 receives a message from a component of the system 200 (e.g., from a settop box 201 or from a server 204, 205, 208 residing in the system 200). For example, in one embodiment, the routing module 700 receives a message from the user's settop box 201 over the network 202 depicted in FIG. 2. In this particular example, the message may contain user input indicating a request from the user to access the provider's VOD service.

In Step 720, the routing module 700 interprets the message and determines the message is intended for a particular component of the system 220 and in response directs the message to the corresponding component of the system 200. For instance, in the example, the routing module 700 directs the message to the VOD server 205.

The VOD server 205 may then respond to the message (e.g., user's request) and send a message back to the user's settop box 201. The routing module 700 receives the message (shown as Step 710), interprets the message (shown as Step 720), and directs the message to the user's settop box 201 (shown as Step 730). Thus, in various embodiments, the routing module 700 is configured to receive and manage all traffic (e.g., messages) between the settop boxes 201 connected to the provider's system 200 and the components located as the head end of the provider's system. Furthermore, in various embodiments, the routing module 700 may also receive and manage traffic among the components at the head end of the user's system 200.

### I-Frame Module

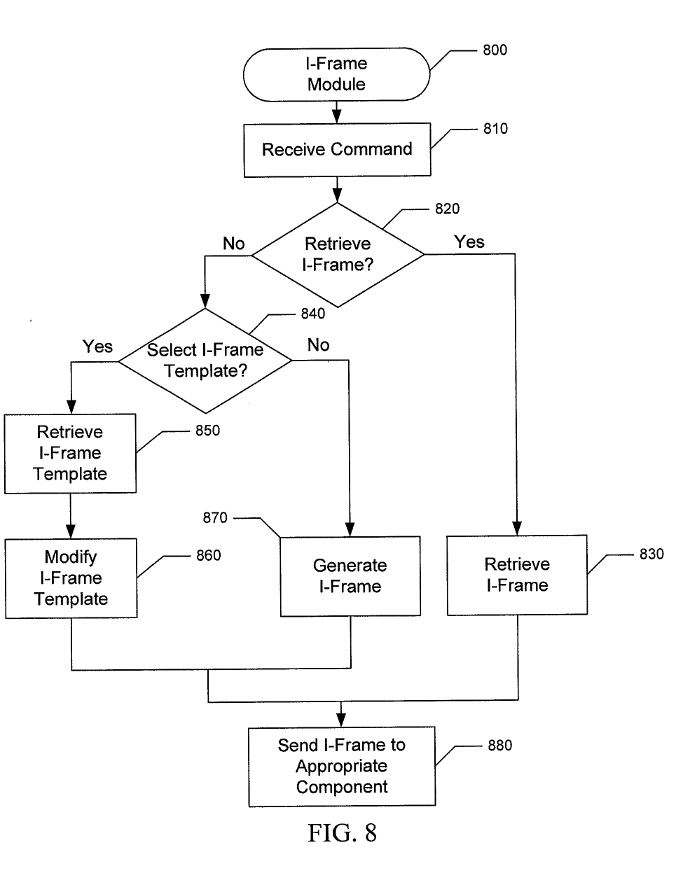

In various embodiments, an I-frame module 800 resides on the I-frame server 204 depicted in FIGS. 2 and 4 and is configured to provide I-frames based on commands received from various components of the system 200. Accordingly, FIG. 8 illustrates a flow diagram of an I-frame module 800 according to various embodiments. This flow diagram may correspond to the steps carried out by the processor 60 in the server 204 shown in FIG. 4 as it executes the module 800 in the server's 204 RAM memory 67 according to various embodiments.

In various embodiments, the I-frame module 800 receives a command sent from a component of the system 200 to provide an I-frame, shown as Step 810. For instance, the I-frame module 800 may receive a command from the VOD server 205 based on input that was entered by the user into the user's settop box 201. This command may represent many types of requests and may be routed to the I-frame server 204 (and corresponding I-frame module 800) through various channels. For example, the interactive client module 500 (or VOD client module 600) on the user's settop box 201 may receive user input and route the input in a message to the routing server 203. The routing module 700 residing on the routing server 203 may interpret that the message is intended for the VOD server 205 and may route the message to the VOD server 205. The message may include input that indicates the user has requested a search interface to use to search available VOD content offered by the provider. Therefore, the VOD server 205 may send a command to the I-frame module 800 to request an I-frame to provide such an interface.

In various embodiments, the command may include various instructions for the I-frame module 800 to perform. For example, the command may include an instruction requesting the I-frame module 800 to retrieve a particular I-frame stored in one or more storage medium. For instance, a pool of I-frames may be maintained that contains I-frames that are used for a plurality of users (e.g., the provider's subscribers). In various embodiments, the use of such a pool may provide a more efficient process for providing the initial search interface than generating the I-frame each time the VOD server 205 receives a request for the initial search interface. Therefore, after receiving the command requesting the I-frame, the I-frame module 800 determines from the command whether to retrieve the I-frame from the pool of I-frames, shown as Step 820.

In various embodiments, the pool of I-frames is stored in storage medium in communication with the I-frame server 204. For example, in one embodiment, the pool of I-frames is stored in the I-frame storage 210 shown in the system 200 depicted in FIG. 2. Thus, in response, the I-frame module 800 accesses the storage 210 and retrieves the desired I-frame, shown as Step 830.

Returning to the example provided above in which the user requests a search interface that includes a text box, the I-frame module 800 receives the command from the VOD server 205 for an I-frame that provides an image for such a search interface. Since this interface is used multiple times for multiple users, the command instructs the I-frame module 800 to retrieve the I-frame that provides the interface from the pool of I-frames.

Once retrieved, the I-frame module 800 sends the I-frame to the appropriate component, shown as Step 880. For instance, in one embodiment, the I-frame module 800 sends the I-frame to the VOD server 205 and the VOD server 205 forwards the I-frame in a message to the routing server 203 (and corresponding routing module 700). In this particular embodiment, the routing module 700 interprets the message and determines the message is intended for the user's settop box 201 and forwards the message to the user's settop box 201.

In other embodiments, the I-frame may be routed to the settop box 201 differently. For example, in another embodiment, the I-frame module 800 sends the I-frame directly to the routing server 203. While in another embodiment, the VOD server 205 (or I-frame server 204) sends the I-frame directly to the user's settop box 201.

In the example, the settop box 201 receives the I-frame and decodes the I-frame into a signal displaying an image of the initial interface with the text box to the user. At this point, the user may wish to search for available VOD content starring Tom Cruise and may begin to enter “Tom Cruise” into the text box. The user types in the letter “T” and the interactive client module 500 receives input and sends the input in a message to the routing server 203. The routing server 203 evaluates the message and routes the message to the VOD server 205. As is described in further detail below, the VOD server 205 stores the user input, determines that an I-frame is needed based on the input, and sends a command to the I-frame module 800 to provide an I-frame based on the user input.

In this particular instance, the command may instruct the I-frame module 800 to construct the I-frame since the user has entered distinct input (e.g., the letter “T”). Therefore, the I-frame module 800 receives the command (shown as Step 810) and determines not to retrieve the I-frame from the pool (shown as Step 820).

In various embodiments, the I-frame module 800 may construct the desired I-frame using various techniques. For instance, the I-frame module 800 may retrieve a template I-frame from the pool and modify the I-frame based on the command. In another instance, the I-frame module 800 may simply generate the I-frame. Therefore, in response to determining to construct an I-frame, the I-frame module 800 determines whether to select an I-frame template or whether to generate an I-frame, shown as Step 840.

In various embodiments, the command received from the VOD server 205 may instruct the I-frame module 800 to select a particular template I-frame from the I-frame pool and modify the particular template I-frame based on the user's input. Therefore, the I-frame module 800 retrieves the I-frame template (shown as Step 850) and modifies the I-frame template based on the user input (shown as Step 860).

For example, the command may instruct the I-frame module 800 to retrieve an I-frame template of the user interface displaying the text box from the I-frame pool and to modify the template to display the letter “T” in the text box. In response, the I-frame module 800 retrieves the I-frame template from the pool and modifies the template to provide an image of the user interface with the letter “T” typed in the text box.

In other embodiments, the command received from the VOD server 205 may instruct the I-frame module 800 to simply generate an I-frame based on the user's input. Therefore, at Step 870, the I-frame module 800 generates the I-frame to provide an image of the user interface with the letter “T” typed in the text box.

Once the I-frame module 800 has generated the I-frame, the module 800 sends the I-frame to the appropriate component of the system 200, shown as Step 880. For instance, the I-frame module 800 sends the I-frame to the VOD server 205 and the server 205 sends the I-frame to the routing server 203 (or the I-frame module 800 sends the I-frame directly to the routing server 203). The routing server 203 forwards the I-frame to the user's settop box 201. The settop box 201 receives the I-frame, decodes the I-frame into a signal displaying an image on the user's television screen which shows the interface with the letter “T” typed in the text box. As a result, it appears to the user as though he or she has just typed the letter “T” into the text box.

This same process is repeated for each letter the user types into the text box. Therefore, the user next enters the letter “o” and the interactive client module 500 sends the input to VOD server 205. The VOD server 205 evaluates the input and sends a command to the I-frame module 800. In this case, the command may instruct the I-frame generate 800 to retrieve a template of the user interface displaying the text box and to modify the template to display the user input in the text box. The I-frame module 800 receives the command, retrieves the I-frame template from the I-frame pool, and modifies I-frame template to provide an image that displays the interface with the letters “To” typed in the text box. The I-frame module 800 sends the I-frame to the VOD server 205 and the VOD server 205 forwards the I-frame to the user's settop box 201. The settop box 201 decodes the I-frame into signal displaying an image on the user's television screen. As a result, it appears to the user as though he or she has typed the letters “To” into the text box.

In addition, as previously discussed, the interface of various embodiments may also include a mechanism, such as a button, to select in order to conduct a search on the entered alphanumeric characters. Therefore, in the example, once the user has entered the characters “Tom Cruise,” the user selects the “Search” button provided on the interface. As is discussed in greater detail below, the VOD server 205 includes a VOD module 900 to conduct the search of the available content to identify the content that satisfies the search criteria. Thus, the module 900 searches the available VOD content for content that satisfies the search criteria (e.g., searches for content that satisfies the criteria “Tom Cruise”).

Once the VOD module 900 has compiled the search results, the module 900 sends a command along with the search results to the I-frame module 800. In this case, the command may instruct the I-frame module 800 to generate the desired I-frame. In response, the I-frame module 800 receives the command and generates the I-frame based on the search results and sends the I-frame to the VOD server 205. The VOD server 205 then routes the I-frame to the user's settop box 201. The settop box 201 receives the I-frame, decodes the I-frame into a signal displaying an image on the user's television screen so that the user may view the search results.

Furthermore, in various embodiments, the I-frame module 800 is also configured to provide I-frames based on web content. For instance, this process may be used to provide the user with an Internet browser through the user's settop box 201. In various embodiments, the user may request to view web content on his or her television set. The user selects the service on his or settop box 201 and the user's request is sent to the interactive client module 500 that indicates the user would like to access the Internet.

In a particular embodiment, the interactive client module 500 forwards the user's request in a message to the routing server 203 and the server 203 directs the message to the web server 208 depicted in FIG. 2. The web server 208 may request an initial screen (e.g., menu) from the I-frame module 800 and the module 800 provides the initial screen that allows the user to direct where on the Internet he or she wishes go. For example, the user may indicate that he or she would like to access YouTube® over the Internet. The web server 208 may access YouTube® over the Internet and may provide the I-frame module 800 with a command along with information (e.g., content) on the initial web page for YouTube®.

The command may instruct the I-frame module 800 to generate an I-frame based on the gathered information. In response, the I-frame module 800 generates the I-frame based on the information and sends the I-frame to the web server 208. The web server 208 forwards the I-frame to the user's settop box 210. The settop box 201 decodes the I-frame into a signal displaying an image of the web content. Therefore, in the example, the user can now see on his or her television screen the initial web page for YouTube®. The user enters search criteria to locate a desired movie on the web site. As the user enters search criteria, the process is repeated and the I-frame module 800 generates I-frames to provide images of the web site screen with the entered text.

Once the user has entered the desired search criteria, the web server 208 submits the search criteria on the web site (e.g., YouTube®). The web server 208 receives the results of the search and sends a command along with the results to the I-frame module 800. In turn, the I-frame module 800 retrieve, modifies, or generates (based on the command) an I-frame based on the search results and sends the I-frame to the web server 208. The web server 208 forwards the I-frame to the user's settop box 201 and the settop box 201 decodes the I-frame into a signal displaying an image to the user. The user can now see the results of the search on his or her television screen. As a result, it appears to the user as though he or she is accessing YouTube® on his or her television set and searching for content on YouTube®.

Furthermore, in various embodiments, the I-frame module 800 may insert advertising content into I-frames. For instance, in one embodiment, the I-frame generator 800 may generate (or select) an I-frame based on a received command and may modify the I-frame to include a particular advertisement. In one embodiment, the advertisement may be sent along with the command for the I-frame from a component in the system 200. For example, the VOD server 205 may send an advertisement along with a command to request an interface. In another embodiment, the I-frame module 800 may retrieve the advertisement from the pool of I-frames or may access the advertisement from an external system, such as the Internet.

In addition, in further embodiments, the I-frame module 800 may include particular advertisement in the I-frame based on the user's input. For example, the user may have entered search criteria indicating that the user wishes to search the provider's available VOD content for content related to Tom Cruise. The VOD server 205 may send a command to generate an I-frame for displaying the search results along with an instruction for advertisement. Thus, the I-frame module 800 may generate an I-frame with the search results along with an advertisement to purchase DVD discs or Blu-Ray discs for films staring Tom Cruise. In other embodiments, the I-frame module 800 may include particular advertisement in the I-frame based on the particular user. For example, the provider may store preferences associated with the user (e.g., may store past searches conducted by the user or may store past VOD content selections viewed by the user) and may include advertisements for VOD content the provider may think the user may be interested in based on the user's preferences.

Furthermore, in various embodiments, the I-frame module 800 may modify the generated or retrieved I-frames based on the user's preferences. In one embodiment, these preferences may be included along with the command received from the system 200 component. In another embodiment, these preferences may be stored along with the pool of I-frames in the I-frame storage 210. For instance, the user may indicate that he or she prefers the images provided from the I-frames to look a certain way. For example, the user may indicate in his or her preferences a certain background to use for each image provided, such as a photograph of the user's children or pets. Thus, in one embodiment, the photograph is stored along with the pool of I-frames and the I-frame module 700 retrieves the photograph and modifies each generated and/or retrieved I-frame to include the preferred photograph as the background. As a result, the user receives, for example, the search interface with a background displaying the user's children. In various embodiments, these preferences may include many types of modifications such as particular search tools to include on interfaces (e.g., buttons, text boxes, and/or drop downs), particular fonts and colors to use on interfaces, and particular positions of items on interfaces (e.g., particular layout of interfaces).

It should be appreciated by one of ordinary skill in the art that the I-frame module 800 may be configured in various embodiments to evaluate the user's input to determine what process should be followed to provide the desired I-frame to the user's settop box 201. Thus, in these particular embodiments, the I-frame module 800 does not receive explicit commands (e.g., instructions) from the system 200 components on whether to retrieve, modify, and/or generate an I-frame. Instead, the I-frame module 800 is configured to evaluate the user's input to determine the proper process to follow.

Finally, in alternative embodiments, the I-frame module 800 may be configured to direct traffic to the various components of the system 200. In this regard, the I-frame module 800 is configured to operate similar to the routing module 700. Thus, in various embodiments, the interactive client module 500 (and/or VOD client module 600) routes the user's input directly to the I-frame module 800 and the I-frame module 800 determines what actions need to be taken based on the input. For example, the input may indicate that the user would like to bring up the VOD search interface on the user's television screen. In this case, the I-frame module 800 determines the user's request from the input and retrieves the I-frame that provides the initial VOD search interface from the I-frame pool and returns the I-frame to the user's settop box 201.

One advantage of such an embodiment is that, in certain cases, the I-frame generator 800 provides I-frames to the settop box 201 without having to channel the input (e.g., user's request) through other components of the system 200. As a result, in various embodiments, the I-frame generator 800 may provided the I-frame faster than in cases where the input is first channeled through the corresponding components (such as the VOD server 205 and/or web server 208) to the I-frame module 800.

### VOD Module

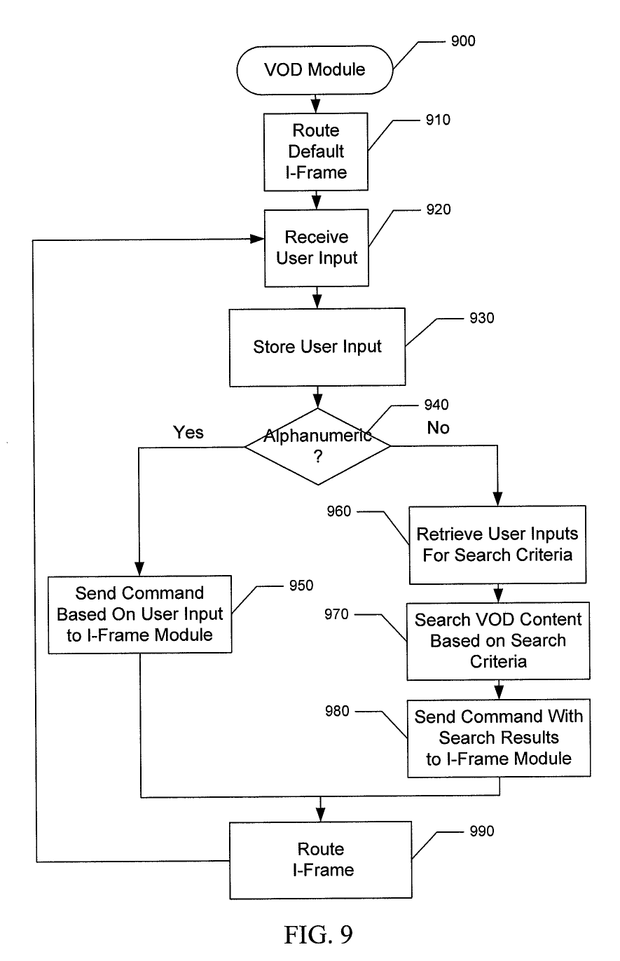

As discussed above, in various embodiments, the VOD module 900 is configured to receive user input, request I-frames based on user input, and search for VOD content based on criteria entered by the user. Accordingly, FIG. 9 illustrates a flow diagram of the VOD module 900 according to various embodiments. This flow diagram may correspond to the steps carried out by a processor in the VOD server 205 as it executes the module 900 in the server's 205 RAM memory according to various embodiments.

In various embodiments, the VOD module 900 receives a request from the user to provide a VOD user interface to search for available VOD content and the VOD module 900 routes a default I-frame to the user's settop box 201, shown as Step 910. As previously discussed, the VOD module 900 may provide the default I-frame by sending a command to the I-frame module 800 requesting the I-frame module 800 to retrieve the I-frame from the I-frame pool and to send the I-frame to the VOD module 900. The VOD module 900 receives the I-frame and routes the I-frame to the user's settop box 201. The settop box 201 receives the I-frame and decodes the I-frame into a signal displaying an image of the user interface on the user's television screen.

As previously discussed, the user interface in various embodiments may display one or more mechanisms for searching the provider's available VOD content. For instance, the user interface may display a text box that the user can enter search criteria into and a “Search” button the user can select to perform a search on the entered criteria. Thus, the user begins to type in alphanumeric characters into the text box via an input device such as a remote control or a keyboard in communication with the settop box 201. In various embodiments, the user input is received by the client interactive module 500 and/or the VOD client module 600 that resides on the user's settop box 201 and the settop box 201 routes a message with the user's input to the VOD server 205.

In various embodiments, the VOD module 900 residing on the VOD server 205 receives the user input, shown as Step 920, and stores the input in memory, shown as Step 930. For example, in one embodiment, the VOD module 900 stores the input in a buffer. In another embodiment, the VOD module 900 stores the input in a storage medium.

In Step 940, The VOD module 900 then determines whether the input is alphanumeric. If the VOD module 900 determines the input is alphanumeric, in various embodiments, the VOD module 900 then sends a command to I-frame module 800 based on the user's input, shown as Step 950. This command may include various information and instructions used by the I-frame module 800 to provide an I-frame to the VOD module 900. For example, the command may include instructions to retrieve an I-frame template and to modify the template to provide an image of the user interface displaying the user input in the text box.

The I-frame module 800 sends the I-frame to the VOD module 900 and the VOD module 900 routes the I-frame to the user's settop box 201, shown as Step 990. The settop box 201 receives the I-frame and decodes the I-frame into a signal displaying an image of the user interface with the user input typed in the text box. In various embodiments, this process is repeated for each alphanumeric character entered by the user.

Once the user has completed entering the desired search criteria, the user selects the “Search” button provided on the user interface. In various embodiments, the selection of the “Search” button sends non-alphanumeric input to settop box 201 which is routed to the VOD module 900. The VOD module 900 receives the input, shown as Step 920, and stores the input in memory, shown as Step 930. In this case, in Step 940, the VOD module 900 determines that the user input is not alphanumeric. Thus, the VOD module 900 retrieves the user inputs received prior to the non-alphanumeric input from memory, shown as Step 960.

The retrieved inputs represent the search criteria entered by the user. For example, if the user wishes to search the provider's available VOD content for Western movies, the user may enter “Westerns” as the search criteria. Therefore, as the user enters each character of the criteria, the character is sent to the VOD module 900. The VOD module 900 stores each character in the buffer (e.g., the characters “W,” “e,” “s,” “t,” “e,” “r,” “n,” and “s”). As a result, when the VOD module 900 received the user input indicating the user has selected the “Search” button (e.g., received non-alphanumeric input), the VOD module 900 retrieves “Westerns” from the buffer. Furthermore, in various embodiments, the user inputs are stored in sequential order in the buffer so that the search criteria are retrieved in the correct order for searching.

Once, the VOD module 900 has retrieved the search criteria, the VOD module 900 of various embodiments searches the provider's available VOD content based on the search criteria, shown as Step 970. For instance, in one embodiment, the VOD module 900 searches the available VOD content located on storage medium, such as the VOD content storage 206 shown in the system 200 depicted in FIG. 2. The VOD content may be stored on the storage medium 206 along with information about the available content. For example, one or more programming guides may be stored along with the content to indicate what content is available and associated information about the content. In addition, the program guides may list the type of genre the movie or program falls under (such as horror, comedy, or Western). Furthermore, these guides may also indicate where to locate each particular asset on the storage medium 206.

Thus, returning to the example presented above, the user has entered “Westerns” as the search criteria. In response, the VOD module 900 searches the available VOD content (e.g., program guides) to identify what assets of the available content qualify based on the entered criteria. For example, the search results may list such film titles as “The Good, The Bad, and The Ugly,” “The Alamo,” and “Young Guns.” In Step 980, The VOD module 900 receives the search results and sends a command along with the search results to the I-frame module 800 to request an I-frame be provided with an image displaying the search results. In response, the I-frame module 800 provides the I-frame based on the search results to the VOD module 900 as previously discussed above with regard to the I-frame module 800. Upon receiving the I-frame, the VOD module 900 routes the I-frame to the user's settop box 201, shown as Step 990. The user's settop box 201 receives the I-frame and decodes the I-frame into a signal displaying an image of the search results on the user's television screen

In particular embodiments, the VOD module 900 may also search for web content that satisfy the search criteria. For instance, in one embodiment, the VOD module 900 forwards the criteria to the web content module 1000 and the web content module 1000 uses the criteria to search the Internet for additional content that satisfy the criteria.

### Web Content Module

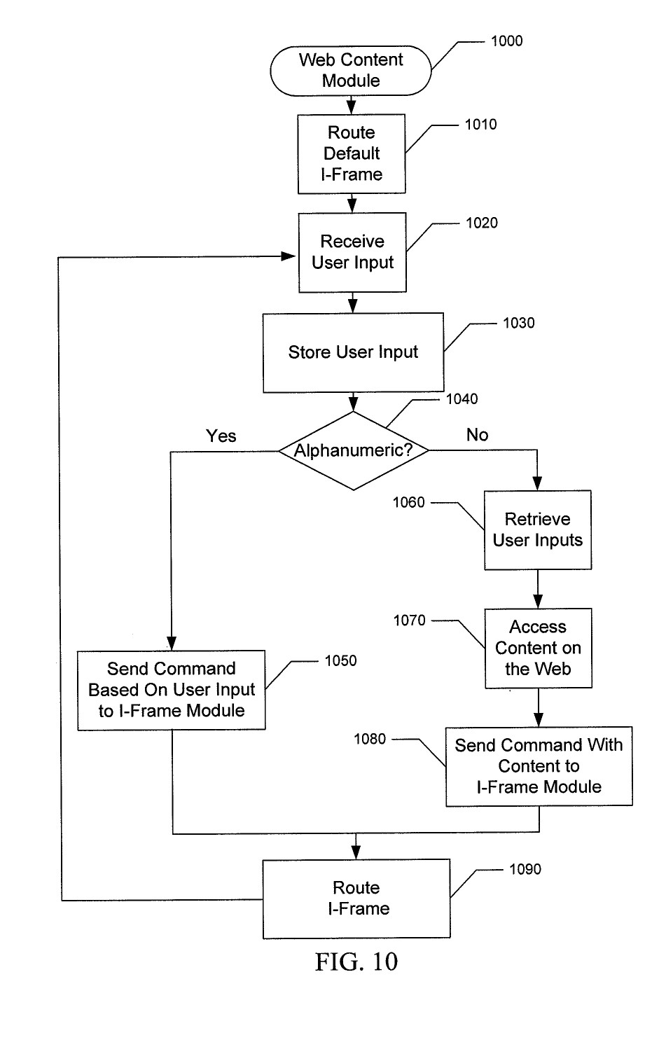

As discussed above, the web content module 900 is configured to search for web content based on input entered by the user. Accordingly, FIG. 10 illustrates a flow diagram of the web content module 1000 according to various embodiments. This flow diagram may correspond to the steps carried out by the processor in the web server 208 as it executes the module 1000 in the server's 208 RAM memory according to various embodiments.

In various embodiments, the web content module 1000 is configured to operate in a similar manner as the VOD module 900. In various embodiments, the web content module 1000 receives a request from the user to provide a browser interface for the Internet and the web content module 1000 routes a default I-frame providing an image of a browser to the user's settop box 201, shown as Step 1010. As previously discussed, the web content module 1000 may provide the default I-frame by sending a command to the I-frame module 800 requesting the I-frame module 800 to retrieve the I-frame from the I-frame pool and to send the I-frame to the web content module 1000. The web content module 1000 receives the I-frame and routes the I-frame to the user's settop box 201. The settop box 201 receives the I-frame and decodes the I-frame into a signal displaying an image of the browser on the user's television screen. For example, the browser may resemble a common browser found on the Internet such as Yahoo®, Google®, and/or YouTube®.

In various embodiments, the user begins to type in alphanumeric characters into the search mechanism provided on the browser and the client interactive module 500 and/or the VOD client module 600 that resides on the user's settop box 201 routes a message with the user input to the web server 208. In various embodiments, the web content module 1000 residing on the web server 208 receives the user input, shown as Step 1020, and stores the input in memory, shown as Step 1030. For example, in one embodiment, the web content module 1000 stores the input in a buffer. In another embodiment, the web content module 1000 stores the input in a storage medium.

In Step 1040, the web content module 1000 determines whether the input is alphanumeric. If the input is alphanumeric, the web content module 1000 then sends a command to the I-frame module 800 based on the user's input, shown as Step 1050. This command may include various information and instructions used by the I-frame module 800 to provide an I-frame to the web content module 1000 based on the user input. For example, in one embodiment, the web content module 1000 (or I-frame module 800) may store an I-frame of the current web page being displayed to the user and the instructions may request the I-frame module 800 to retrieve the stored I-frame and modify the I-frame based on the user's input. While in another embodiment, the web content module 1000 may include instructions requesting the I-frame module 800 to generate the I-frame based on content information provided in the command sent to the I-frame module 800.

The I-frame module 800 provides the I-frame to the web content module 1000 and the module 1000 routes the I-frame to the user's settop box 201, shown as Step 1090. The settop box 201 receives the I-frame and decodes the I-frame into a signal displaying an image of the browser with the user input typed into the search mechanism. In various embodiments, this process is repeated for each alphanumeric character entered by the user.

Once the user has completed entering information into the browser, the user selects the “Search” mechanism provided on the browser. In various embodiments, the selection of the “Search” button sends non-alphanumeric input to settop box 201 which is routed to the web content module 1000 and received by the web content module 1000, shown as Step 1020. In this case, the web content module 1000 stores and input (shown as Step 1030) and determines that the user input is not alphanumeric (shown as Step 1040). In response, the web content module 1000 retrieves the user inputs received prior to the non-alphanumeric input from memory, shown as Step 1060.

Once the web content module 1000 has retrieved the user inputs, the module 1000 accesses content on the web based on the user inputs, shown as Step 1070. For example, in one embodiment, the provided browser may resemble Google® and the user has entered input to search for information on great white sharks (e.g., the user has entered the terms “great white sharks” into the text box provided on the Google® search engine web site). Thus, the web content module 1000 retrieves the input from memory, accesses the Google® web site, and submits the user input on the web site to conduct a search. The Google® web site returns with pages of search results and the web content module 1000 gathers the content from the first page of results. For example, the web content module 1000 performs a data scrape of the first page of search results.

In Step 1080, the web content module 1000 sends a command along with the content to the I-frame module 800 requesting an I-frame be provided based on the retrieved content. In this particular case, the I-frame may generate an I-frame to provide an image displaying the Google® web site with the first page of search results. The I-frame module 800 sends the I-frame to the web content module 1000 and the web content module 1000 routes the I-frame to the user's settop box 201, shown as Step 1090.

The settop box 201 receives the I-frame and decodes the I-frame into a signal displaying an image of the Google® web site with the first page of search results to the user. Thus, it appears to the user as though he or she is accessing Google® and has conducted a search on the terms “great white sharks.”

If the user would like to see the second page of search results, the user selects the “Next” button on the displayed Google® web page and input is sent to the web content module 1000 indicating the user has selected the “Next” button. The web content module 1000 receives the input and saves the input into memory. In various embodiments, this input is characterized as non-alphanumeric and therefore the web content module 1000 retrieves the user's previous inputs from memory and accesses the content on the web site based on the user inputs (e.g., the user's search terms and the user selecting the “Next” button).

Thus, the web content module 1000 submits the user's search terms on the Google® web site, selects the “Search” button, and selects the “Next” page of results. The web content module 1000 gathers the content on the next page of search results and sends a command along with the content to the I-frame module 800 to provide an I-frame based on the content. The I-frame module 800 provides the I-frame and the web content module 1000 routes the I-frame to the user's settop box 201. The settop box 201 decodes the I-frame into a signal displaying an image of the Google® web site with the second page of search results for the terms “great white sharks.” Thus, it appears to the user as though he or she has now moved to the second page of search results.

Furthermore, in various embodiments, the same process is followed once the user has selected a particular site listed in the search results. The user selects the site and the web content module 1000 receives non-alphanumeric character as input. In response, the web content module 1000 retrieves the previous inputs received for the user and accesses the desired web content based on these inputs. Thus, in the example, the web content module 1000 accesses the Google® web site, enters in the search terms “great white sharks,” selects the search button, selects the “Next” button, and selects the particular site in the listing of search results. The particular web site is accessed and the web content module 1000 retrieves the content from the web site and sends a command to the I-frame module 800 to provide an I-frame based on the web site content. The I-frame module 800 generates the I-frame and sends the I-frame to the web content module 1000. The web content module 1000 routes the I-frame to the user's settop box 201 and the settop box 201 decodes the I-frame into a signal displaying an image of the selected web site to the user.

### Conclusion

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

What is claimed is:

1. A system for providing a dynamic user interface comprising:
a network;
a computing device;
an I-frame module; and
a settop box in communication with the computing device over the network, the settop box configured to:
receive more than one inputs from a user, each input comprising an alphanumeric character; and
send each input over the network to the computing device, wherein:
The computing device is configured to:
receive a particular input;
store the particular input in memory along with inputs of the more than one inputs received prior to the particular input; and
send the particular input along with the inputs received prior to the particular input to the I-frame module;
the I-frame module is configured to:
generate an I-frame based on the particular input and the inputs received prior to the particular input; and
route the generated I-frame over the network to the settop box, wherein
the settop box is configured to decode the I-frame to generate a signal for displaying an image to the user.

2. The system of claim 1 further comprising a VOD module, wherein:
the particular input from the user received by the settop box comprises an non-alphanumeric character;
the computing device is configured to send the inputs received prior to the input comprising the non-alphanumeric character to the VOD module in response to receiving the particular input;
the VOD module is configured to:
search video-on-demand (VOD) content for providing a listing of VOD content that satisfies the inputs received prior to the particular input;
send the listing of VOD content to the I-frame module;
the I-frame module is configured to:
generate a second I-frame providing the listing of VOD content; and
route the second I-frame over the network to the settop box; and
the settop box is configured to decode the second I-frame to generate a signal for displaying an image providing the listing of VOD content to the user.

3. The system of claim 2, wherein the inputs are received by the computing device in sequence for conducting the search of the VOD content.

4. The system of claim 2, wherein the settop box is further configured to:
receive a selection of a particular VOD content from the listing of VOD content; and
request the particular VOD content to be streamed or downloaded to the settop box.

5. The system of claim 1, wherein the I-frame module is further configured to generate the I-frame by:
selecting a template I-frame from memory; and
modifying the template I-frame based on the particular input and the inputs received prior to the particular input.

6. The system of claim 1 further comprising a web module, wherein:
the particular input from the user received by the settop box comprises an non-alphanumeric character;
in response to receiving the input, the computing device is configured to send the inputs received prior to the input comprising the non-alphanumeric character to the web module;
the web module is configured to:
access one or more web pages over the network;
receive information from the one or more web pages based on the inputs received prior to the input comprising the non-alphanumeric character;
send the information to the I-frame module;
the I-frame module is configured to:
generate a second I-frame based on the information; and
route the second I-frame over the network to the settop box; and
the settop box is configured to decode the second I-frame to generate a signal for displaying an image to the user.

7. The system of claim 1, wherein the I-frame module is further configured to generate the I-frame by:
selecting advertising content from memory; and
generating the I-frame to include the advertising content.

8. The system of claim 7, wherein the I-frame module selects the advertising content based on the particular input and the inputs received prior to the particular input.

9. The system of claim 7, wherein the I-frame module selects the advertising content based on the user.

10. A computer-implemented method for providing a dynamic user interface comprising the steps of:
receiving more than one inputs from a user at a settop box, each input comprising an alphanumeric character;
sending each input over a network to a computing device;
receiving a particular input of the more than one inputs at the computing device;
storing the particular input in memory along with inputs of the more than one inputs received prior to the particular input;
sending the particular input along with the inputs received prior to the particular input to an I-frame module;
generating an I-frame, by the I-frame module, based on the particular input and the inputs received prior to the particular input;
routing the generated I-frame over the network to the settop box; and
decoding the I-frame on the settop box to generate a signal for displaying an image to the user.

11. The method of claim 10, wherein the particular input comprises a non-alphanumeric character and the method further comprises the steps of:
sending the inputs received prior to the input comprising the non-alphanumeric character to a VOD module in response to receiving the particular input;
searching, by the VOD module, video-on-demand (VOD) content for providing a listing of VOD content that satisfies the inputs received prior to the input comprising the non-alphanumeric character;
sending the listing of VOD content to the I-frame module;
generating, by the I-frame module, a second I-frame providing the listing of VOD content; and
routing the second I-frame over the network to the settop box; and
decoding the second I-frame on the settop box to generate a signal displaying an image of the listing of VOD content to the user.

12. The method of claim 11, wherein the more than one inputs are received by the computing device in sequence for conducting the searching step.

13. The method of claim 11 further comprising the steps of:
receiving a selection of a particular VOD content from the listing of VOD content by the settop box; and
requesting the particular VOD content to be streamed or downloaded to the settop box for displaying to the user.

14. The method of claim 10, wherein the generating step comprises the sub-steps of:
selecting a template I-frame from memory; and
modifying the template I-frame based on the particular input and the inputs received prior to the particular input.

15. The method of claim 10, wherein the particular input comprises a non-alphanumeric character and the method further comprises the steps of:
sending the inputs received prior to the input comprising the non-alphanumeric character to a web module in response to receiving the particular input;
accessing one or more web pages over the network by the web module;
receiving, by the web module, information from the one or more web pages based on the inputs received prior to the input comprising the non-alphanumeric character;
sending the information to the I-frame module;
generate, by the I-frame module, a second I-frame based on the information; and
routing the second I-frame over the network to the settop box; and
decoding the second I-frame on the settop box to generate a signal displaying an image to the user.

16. The method of claim 10, wherein the generating step comprises the sub-steps of:
selecting advertising content from memory; and
generating the I-frame to include the advertising content.

17. The method of claim 16, wherein selecting sub-step is carried out by selecting the advertising content based on the particular input and the more than one inputs received prior to the particular input.

18. The method of claim 16, wherein selecting sub-step is carried out by selecting the advertising content based on the user.
